(19) United States
(12) Patent Application Publication
(10) Pub. No.: US 2015/0134623 A1
(43) Pub. Date: May 14, 2015

(54) PARALLEL DATA PARTITIONING

(71) Applicant: Yong Steven Liu, Singapore (SG)

(72) Inventor: Yong Steven Liu, Singapore (SG)

(73) Assignee: JITCOMM NETWORKS PTE LTD, Singapore (SG)

(21) Appl. No.: 14/000,094

(22) PCT Filed: Feb. 17, 2011
(86) PCT No.: PCT/SG11/00068

§ 371 Date: Jul. 22, 2014

(51) Int. Cl. G06F 11/14; G06F 17/30

(52) U.S. Cl. CPC G06F 11/1453; G06F 17/30584; G06F 17/30156
USPC 707/692

(57) ABSTRACT

A method, system, and data storage medium for parallel partitioning of input data into chunks for data deduplication, comprising: dividing said input data into segments; for at least one segment, appending a portion of a subsequent segment; searching the segments in parallel for candidate breaking points; and partitioning each segment into chunks based on a group of final breaking points selected from said candidate breaking points.

### FIELD OF INVENTION

The present invention broadly relates to data deduplication, and, more particularly, to parallel partitioning of data for data deduplication.

### BACKGROUND

Data deduplication involves the reduction or elimination of redundant data. Data previously stored in a data storage system can be processed to reduce storage capacity requirements by reducing redundant data. Additionally, data deduplication can be used to reduce the amount of data transmitted over networks in wide area network (WAN) optimisation systems. During data deduplication, input data of an input data stream is partitioned into various chunks and each chunk is compared with stored history information to determine whether the chunk is redundant. The chunk is redundant if the chunk is determined to be a duplicate of another previously stored chunk. The chunk is likely to be redundant if the hash value of the chunk is the same as the hash value of another chunk that has been previously stored. For such redundant chunks, a short pointer that points to the previously stored chunk or the hash value of the redundant chunk is stored instead of the actual chunk data, resulting in savings of storage space. Data chunks that are not redundant can be transmitted or stored, and chunk history information is updated.

The two main types of data deduplication for data storage are inline and offline deduplication. Inline deduplication is performed by a device in a data path before data is stored in a storage device. Inline deduplication may reduce the disk capacity required to store electronic data, thereby increasing cost savings. Disadvantages of inline deduplication are that the data is processed while being transmitted, which may result in reduced performance. Further, inline deduplication is performed sequentially which further impedes performance. The other type of deduplication, offline deduplication, has been used to reduce duplicate data after the data is stored in the storage device. However, one disadvantage of offline deduplication is the additional storage capacity required for storage of the data. Another disadvantage is that offline deduplication cannot be utilised for data reduction over networks in WAN optimisation systems since the reduction of data size must occur prior to the transmission of the data over the networks. In order to allow the efficient implementation of inline deduplication and offline deduplication, an improvement in performance for data deduplication is desired.

The computationally extensive main tasks of a data deduplication system are the partitioning of input data into various chunks and computation of hash values for each chunk. There are two different basic approaches to data partitioning, which are block level (fixed sized) data partitioning and byte-level (variable sized) data partitioning. The block level approach is to partition the input data into chunks that are all of the same size. The block level approach to data partitioning is simple and fast. The problem with such a fixed size chunk approach is that a small difference from insertion or deletion of bytes in the input data will change not just one chunk, but the change will also cause cascading changes to many subsequent chunks. Much of the potential savings in storage space or reduced quantity of transmission data is missed because the cascading changes affect the content of otherwise redundant chunks.

A better approach to find redundancy between two files is to partition the input data according to content, as discussed by U. Manber, “Finding Similar Files in a Large File System”, Usenix Winter 1994 Technical Conference, San Francisco (January 1994), pp. 1-10. In a content-based approach, a fingerprint (which can be computed by using a hash function) is computed for all overlapping data blocks of the input data. A “data block” is a contiguous group of data that may be used to determine a breaking point corresponding to a right-side end of a chunk. If the fingerprint of an overlapping data block satisfies some criteria, a breaking point is placed at the end of the overlapping data block to identify a new chunk. Then, the process starts from the next byte after the breaking point and the procedure is repeated to find the next breaking point for the next chunk, and so on. With this approach, a small change in a data chunk will only affect adjacent chunks.

The content-based approach has been discussed in Athicha Muthitacharoen et al. “A Low-bandwidth Network File System”, Proceedings of the 18th Symposium on Operating Systems Principles, Banff, Canada (October 2001). In this work, the file content is partitioned to various chunks according to content and each chunk is represented by a unique hash value. Before sending a file over a network to a server, each chunk is compared with a history dictionary to determine whether the content has been sent earlier. If the content has been sent earlier, only the hash value needs to be sent for the repeated chunks such that the amount of network traffic is reduced.

The content-based approach has also been discussed in N. T. Spring et al., “A protocol-independent technique for eliminating redundant network traffic”, ACM SIGCOMM Computer Communication Review, Volume 30, Issue 4 (October 2000). In this work, network traffic is partitioned to various chunks according to content. Both a sending end and a receiving end of a network communication maintain a cache to store all the chunks sent and received. Each chunk of an incoming network packet is compared against the cache to determine whether the same chunks have previously arrived or not. If the chunk has been received before, the repeated chunk will be encoded in a shorter form to eliminate redundant network traffic.

Content-based data partitioning is very computationally intensive as every overlapping data block of the input data is analysed and a fingerprint is computed and compared for each of the overlapping data blocks. The content-based data partitioning becomes the bottleneck for an efficient data deduplication system, which significantly limits the throughput of the data deduplication system. That is why offline data deduplication system is used when online data deduplication system cannot keep up with the speed of an input data stream. However, offline deduplication requires large storage media and is unsuitable for network optimization since the data deduplication is performed prior to data transmission. In order to meet the demands of inline deduplication and offline deduplication discussed above, an efficient approach to content-based partitioning of data is desired for an efficient high throughput data deduplication system.

### SUMMARY

One aspect of the present invention provides a method of parallel partitioning of input data into chunks for data deduplication, comprising: dividing said input data into segments; for at least one segment, appending a portion of a subsequent segment; searching the segments in parallel for candidate breaking points; and partitioning each segment into chunks based on a group of final breaking points selected from said candidate breaking points.

Said portion of said subsequent segment may comprise data at the beginning of said subsequent segment.

The method may further comprise upon determining a distance of a particular candidate breaking point to be less than a minimum distance from a last breaking point, excluding said particular candidate breaking point from said group of final breaking points.

The method may further comprise determining a distance of a particular candidate breaking point to be greater than a maximum distance from a last breaking point; and upon determining that said distance is greater than said maximum distance, setting a chunk size of a chunk to be equal to a maximum chunk size.

The method may further comprise determining that a distance of a particular candidate breaking point from a last breaking point is greater than a minimum breaking point distance and that said distance of said particular candidate breaking point from said last breaking point is less than a maximum breaking point distance; and upon said determining, adding said particular candidate breaking point to said group of final breaking points.

Searching the segments in parallel for candidate breaking points may further comprise adding a candidate breaking point to said group of final breaking points if a fingerprint of a data block satisfies a fingerprint criteria.

Dividing said input data into segments may further comprise dividing said input data into segments of a same size or different size.

Searching the segments may be performed either by searching data blocks in parallel or by searching said data blocks in serial.

A size of said appended portion of said subsequent segment may be at most one byte less than a size of an overlapping data block.

The method may further comprise computing, in parallel, chunk fingerprints for said chunks after said partitioning.

The method may further comprise each of said segments is appended with a portion from a subsequent segment except for a last segment.

Said steps of dividing, searching, and partitioning may be applied to multiple input data streams in parallel.

A further aspect of the present invention provides a system for parallel partitioning of input data into chunks for data deduplication, comprising: means for dividing said input data into segments; means for appending, for at least one segment, a portion of a subsequent segment; means for searching the segments in parallel for candidate breaking points; and means for partitioning each segment into chunks based on a group of final breaking points selected from said candidate breaking points.

Said portion of said subsequent segment of the system may comprise data at the beginning of said subsequent segment.

The system may further comprise means for excluding a particular candidate breaking point from said group of final breaking points upon determining a distance of said particular candidate breaking point to be less than a minimum distance from a last breaking point.

The system may further comprise means for determining a distance of a particular candidate breaking point to be greater than a maximum distance from a last breaking point; and upon determining that said distance is greater than said maximum distance, setting a chunk size of a chunk to be equal to a maximum chunk size.

The system may further comprise means for determining that a distance of a particular candidate breaking point from a last breaking point is greater than a minimum breaking point distance and that said distance of said particular candidate breaking point from said last breaking point is less than a maximum breaking point distance; and upon said determining, adding said particular candidate breaking point to said group of final breaking points.

Said means for searching the segments in parallel for candidate breaking points of said system may further comprise means for adding a candidate breaking point to said group of final breaking points if a fingerprint of a data block satisfies a fingerprint criteria.

A size of said appended portion of said subsequent segment of said system may be at most one byte less than a size of an overlapping data block.

A further aspect of the present invention provides a data storage medium having stored thereon computer code means for instructing a parallel processing system to execute a method of parallel partitioning of input data into chunks for data deduplication, comprising: dividing said input data into segments; for at least one segment, appending a portion of a subsequent segment; searching the segments in parallel for candidate breaking points; and partitioning each segment into chunks based on a group of final breaking points selected from said candidate breaking points.

The data storage medium may have stored thereon further computer code means for excluding a particular candidate breaking point from said group of final breaking points upon determining a distance of said particular candidate breaking point to be less than a minimum distance from a last breaking point.

The data storage medium may have stored thereon further computer code means for determining a distance of a particular candidate breaking point to be greater than a maximum distance from a last breaking point; and upon determining that said distance is greater than said maximum distance, setting a chunk size of a chunk to be equal to a maximum chunk size.

The data storage medium may have stored thereon further computer code means for determining that a distance of a particular candidate breaking point from a last breaking point is greater than a minimum breaking point distance and that said distance of said particular candidate breaking point from said last breaking point is less than a maximum breaking point distance; and upon said determining, adding said particular candidate breaking point to said group of final breaking points.

Said computer code means for searching the segments in parallel for candidate breaking points may further comprise computer code means for adding a candidate breaking point to said group of final breaking points if a fingerprint of a data block satisfies a fingerprint criteria.

The data storage medium may have stored thereon further computer code means wherein a size of said appended portion of said subsequent segment is at most one byte less than a size of an overlapping data block

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1a illustrates data partitioning using the fixed sized chunk approach.

FIG. 1b illustrates data partitioning using a variable size chunk approach.

FIG. 2 illustrates searching through overlapping data blocks of an input data stream for breaking points corresponding to chunks.

FIG. 3a and FIG. 3b illustrate dividing two different, but very similar, input data streams into multiple segments using a simplistic approach to parallel processing.

FIG. 4 illustrates a multi-stage process for determining final breaking points, according to an embodiment.

FIG. 5 illustrates construction of overlapping segments, according to an embodiment.

FIG. 6 illustrates searching for candidate breaking points in an overlapping segment, according to an embodiment.

FIG. 7 illustrates a flowchart for determining a final breaking point group, according to an embodiment.

FIG. 8 illustrates a block diagram of a data deduplication system with a parallel data partitioning card, according to an embodiment.

FIG. 9 illustrates a block diagram of a computer system upon which embodiments can be implemented.

FIG. 10 illustrates a flowchart for parallel partitioning of input data into chunks for data deduplication, according to an embodiment.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code and/or hardware logic using field programmable gate arrays (FPGA) or application specific integrated circuits (ASIC) described by hardware description language such has VHDL or Verilog HDL. The computer program is not intended to be limited to any particular programming language and implementation thereof. It will be appreciated that a variety of programming languages and coding thereof may be used to implement the teachings of the disclosure contained herein. Moreover, the computer program or the hardware logic is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

As described, embodiments of the invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Embodiments of the invention will be discussed hereinafter with reference to the figures. To provide a more detailed description, the present specification first provides an explanation of the basic principles of data deduplication. The difficulties encountered in designing a parallel process for efficient data partitioning for data deduplication are also discussed, followed by the disclosure of efficient parallel data partitioning according to embodiments of the present invention.

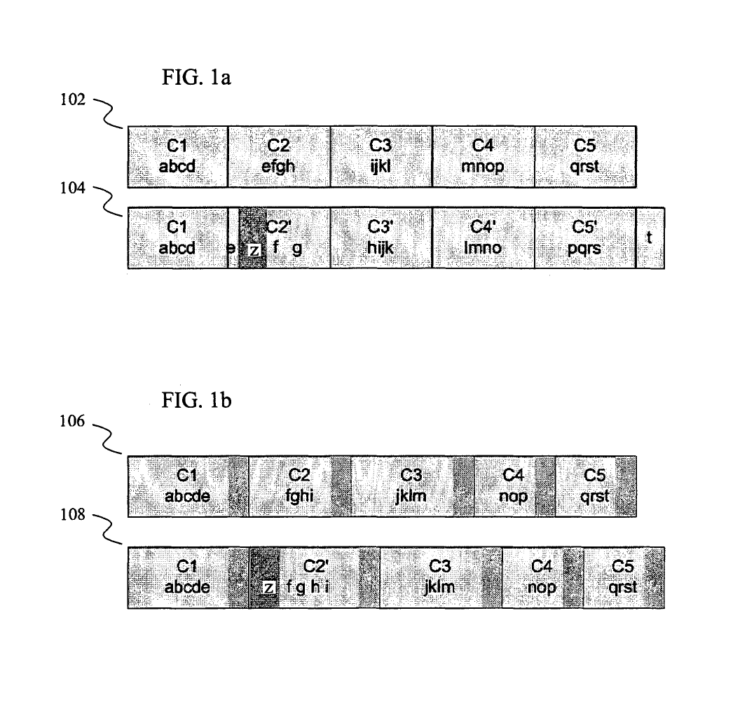

FIG. 1a illustrates data partitioning using the fixed sized chunk (also referred to as fixed sized block) approach. The term “chunk” is used interchangeably with “block”. FIG. 1a depicts two files File 102 and File 104 that are very similar except that File 104 has an extra “z” in chunk C2′. Only a single character ‘z’ distinguishes File 104 from File 102. Because each chunk is limited to the fixed size of four characters, the insertion of the extra “z” in C2′ causes a cascading effect that changes the chunks subsequent to C2′, which are C3′, C4′ and C5′. The new character “z” in chunk C2′ leads to four (4) different new chunks even though File 104 is very similar to File 102. As seen in the example of FIG. 1a, but for the insertion of the extra ‘z’, C3′ would have been redundant to C3, C4′ would have been redundant to C4, and C5′ would have been redundant to C5. However, with the extra ‘z’ in C2′, the opportunity for eliminating redundancy in the storage of File 104 is reduced because File 102 and File 104 only have one common chunk C1. Thus, the storage of File 104 has a significantly decreased data reduction ratio using the fixed sized chunk approach.

FIG. 1b illustrates data partitioning using a variable size chunk approach, also referred to as “byte-level data partitioning”. FIG. 1b illustrates an approach to data partitioning that provides a higher data reduction ratio for removing redundant chunks. In FIG. 1b, the difference of an extra character “z” in the chunk of C2′ does not affect the subsequent chunks C3, C4, and 05, because the size of chunk C2′ expands to accommodate the extra “z”. The data reduction ratio using byte-level data partitioning can be greatly enhanced when compared to block-level data partitioning.

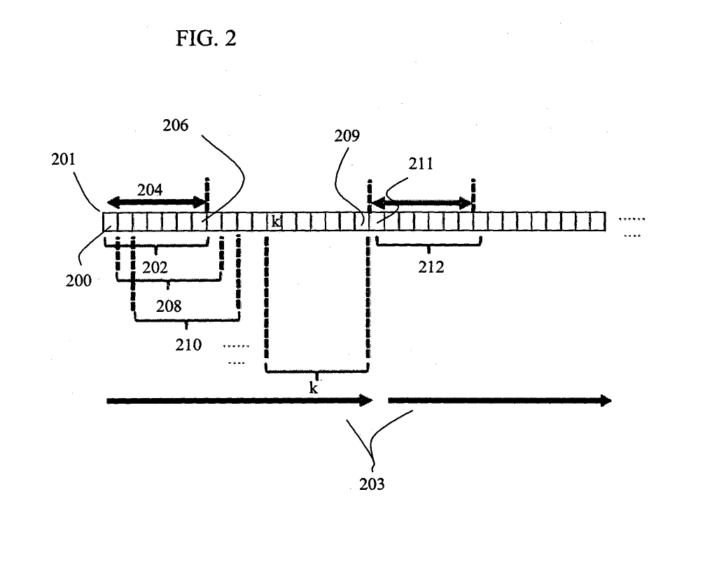

FIG. 2 illustrates searching through overlapping data blocks of an input data stream for breaking points corresponding to chunks. The searching involves partitioning input data according to content by comparing the fingerprint of every overlapping data block of n bytes length against certain fingerprint criteria. Each data block is a contiguous group of data that may be used to determine a breaking point corresponding to a right-side end of a chunk. Data blocks are “overlapping” because a data block with [1, 2, . . . , n] bytes shares some common data with the next data block of [2, 3, . . . n+1] bytes, and data block with [2, 3, . . . n+1] bytes shares some common data with the next data block [3, . . . n+2] bytes, and so on. The length of each data block in the examples is represented by “n”, which has an example value of n=7.

The search for breaking points corresponding to chunks starts from the beginning first byte 200 of the input data stream 201. The arrows 203 indicate the direction of search for breaking points. The data deduplication system begins the search by computing a fingerprint for a data block 202 comprising the first n bytes 204, i.e. [1, 2, . . . , n] bytes, of the input data stream. Next, a comparison is performed to determine if the computed fingerprint meets a certain fingerprint criteria. An example of a fingerprint criteria is discussed in U. Manber, “Finding Similar Files in a Large File System”, Usenix Winter 1994 Technical Conference, San Francisco (January 1994), pp. 1-10. For example, if the last few bits of the binary fingerprint are all zero, the fingerprint is selected. However, it will be appreciated that the present invention is not limited to any specific way of identifying similar data in the data deduplication process, and may for example be applied with different fingerprint criteria in different embodiments. A determination is made whether the resultant chunk size that includes data block 202 also meets a certain chunk size criteria. If both criteria are met, a breaking point is assigned at the n-th byte 206, and the first chunk which comprises bytes [1, 2, . . . , n] is generated.

Otherwise, the data deduplication system computes the fingerprint for data block 208 which consists of the next overlapping n bytes, i.e. [2, 3, . . . n+1]. The data deduplication system determines whether chunk size criteria is satisfied and compares the fingerprint to determine whether a breaking point should be assigned at the (n+1)-th byte. If a breaking point is assigned at the (n+1)-th byte, the first chunk which comprises bytes [1, 2, . . . , n+1] is generated.

Otherwise, the data deduplication system computes the fingerprint for data block 210 which comprises the next overlapping n bytes, i.e. [3, 4, . . . n+2]. The data deduplication system determines whether chunk size criteria is satisfied and compares the fingerprint to determine whether a breaking point should be assigned at the (n+2)-th byte. If a breaking point is assigned at the (n+2)-th byte, the first chunk which comprises bytes [1, 2, . . . , n+2] is generated.

Generally, if a breaking point is assigned at the (k+n)-th byte 209, the first chunk which comprises bytes [1, 2, . . . , k+n] is generated. In FIG. 2, “k” represents the k-th byte, and “k” also represents the k-th data block for which a fingerprint is computed and compared.

From the (k+n+1)-th byte 211, the process of 1) computing fingerprints for comparison and 2) determining whether the resultant chunk size satisfies the chunk size criteria is repeated to look for the next breaking point to determine a next chunk. The next data block 212 for fingerprint computation and comparison begins at the (k+n+1)-th byte 211, and data block 212 consists of bytes [k+n+1, k+n+2, . . . , k+n+n]. The beginning of the next chunk is the (k+n+1)-th byte 211, and the end of the next chunk is determined by searching for the next breaking point.

In the byte-level data partitioning approach discussed with respect to FIG. 2, the fingerprint computing and breaking point process are interleaved. The computation of subsequent breaking points depends on the computation of previous breaking points. Thus, the interleaved byte-level data partitioning described with respect to FIG. 2 has to be performed in serial for the input data stream byte-by-byte. This byte-by-byte serial process significantly affects the processing speed of data deduplication, reducing system throughput of data deduplication systems for network transmission and data storage.

A simplistic approach to attempt to improve the performance of data deduplication is to divide the input data into multiple segments of equal size and search for breaking points in parallel. However, less redundancies are recognised and eliminated with such a simplistic approach, as explained below.

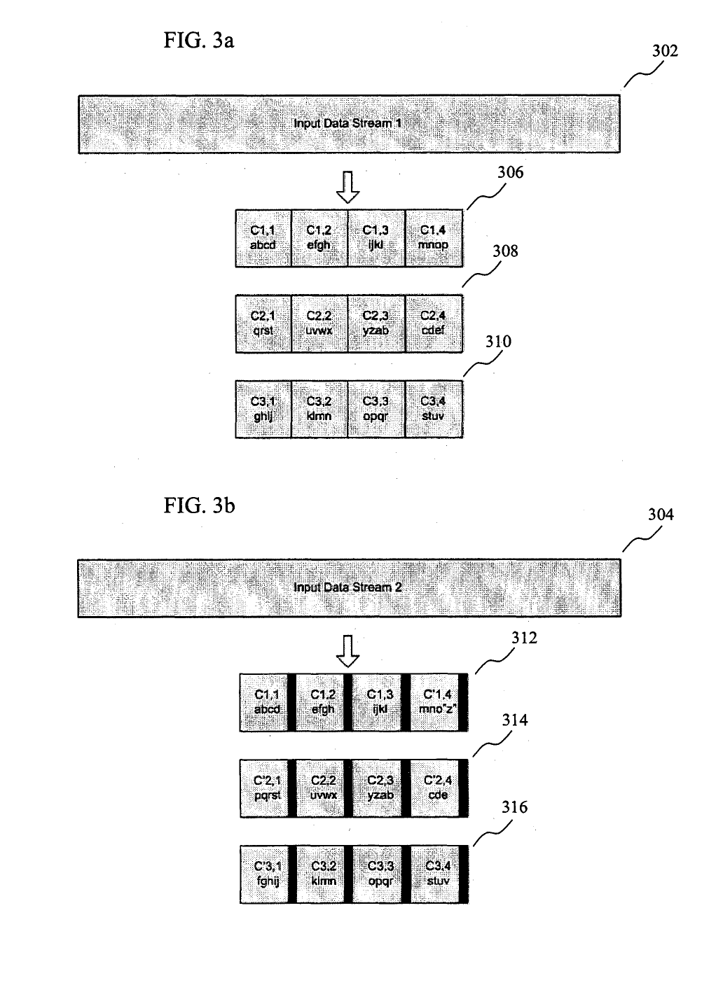

FIG. 3a and FIG. 3b illustrate dividing two different, but very similar, input data streams 302, 304 into multiple segments using the simplistic approach to parallel processing. First input data stream 302 is divided into multiple segments 306, 308, 310. Second input data stream 304 is divided into multiple segments 312, 314, 316.

There is a difference between the two input data streams 302, 304. An additional “z” located in the fourth chunk C′1,4 of the first segment of the second input data stream 304 distinguishes the second input data stream 304 from the first input data stream 302. The introduction of the letter “z” in the second input data stream causes a cascading effect that changes a total of four (4) chunks of the second input data stream 304. Without the extra “z” in the second input data stream 304, the four (4) changed chunks (C′1,4, C′2,1, C′2,4, C′3,1) would have been redundant duplicates of the chunks (C1,4, C2,1, C2,4, C3,1) in the first input data stream 302. Because each segment is limited to a fixed size of 16 bytes (represented as 16 characters in the figures), the introduction of the extra “z” in the second input data stream 304 pushes “p” into the second segment 314. The “f” is also pushed to a third segment 316 because if both “p” and “f” are contained within the second segment 314 then the number of bytes of the second segment 314 exceeds 16 bytes.

The breaking points for most of the chunks are the same between the two input data streams. Most of the chunks of the second input data stream are redundant duplicates of the chunks of the first input data stream. However, for the second input data stream 304, all the bytes located at the boundaries between segments are shifted to the subsequent segment. For example, C2,1 and C′2,1 share the same breaking point but C′2,1 is not a redundant duplicate of C2,1. C3,1 and C′3,1 share the same breaking point but C′3,1 is not a redundant duplicate of C3,1. In fact, all the first and the last chunks in all intermediate segments will be new, different chunks. The different chunks resulting from partitioning of the two input data streams leads to a low data reduction ratio.

Another problem with the simplistic approach to parallel processing is that some breaking points are not detected because a contiguous series of bytes that otherwise would be used in a fingerprint computation in a serial partitioning approach are now divided between two segments in the simplistic parallel processing approach. The search for breaking points begins with the first byte of each segment. The breaking points for the first segment found using the simplistic parallel processing approach are exactly the same as the breaking points that are found using a serial partitioning approach. However, the breaking points found for the second segment might not be the same as the breaking points that would be found from a serial partitioning approach. The reason is the last byte of the first segment is very unlikely to be a breaking point, as the breaking point criteria must be satisfied for that byte. Under most circumstances, there is a small remaining part at the end of the first segment which is not assigned a breaking point, as the size of the remaining part is less than the required minimum chunk size. This remaining part actually should be included in the breaking point computing for the second segment. However, since breaking point computations are performed in parallel for each segment, the search for breaking points for the second segment starts from the first byte of the second segment without the remaining part of the first segment.

Even if the fingerprint of leading bytes of the second segment meets the fingerprint criteria, if the number of leading bytes is below the minimum required for the chunk size, no breaking point will be assigned. If the remaining part of the first segment is-appended to the front of the second segment, the first breaking point will be assigned since the chunk size corresponding to the first breaking point would meet the chunk size criteria. However, the first breaking point of the second segment is thereby shifted. Alternatively, if each remaining part of each segment is treated as a new chunk, there are many small chunks which also affect the data reduction ratio since each chunk is represented by a hash value with constant size.

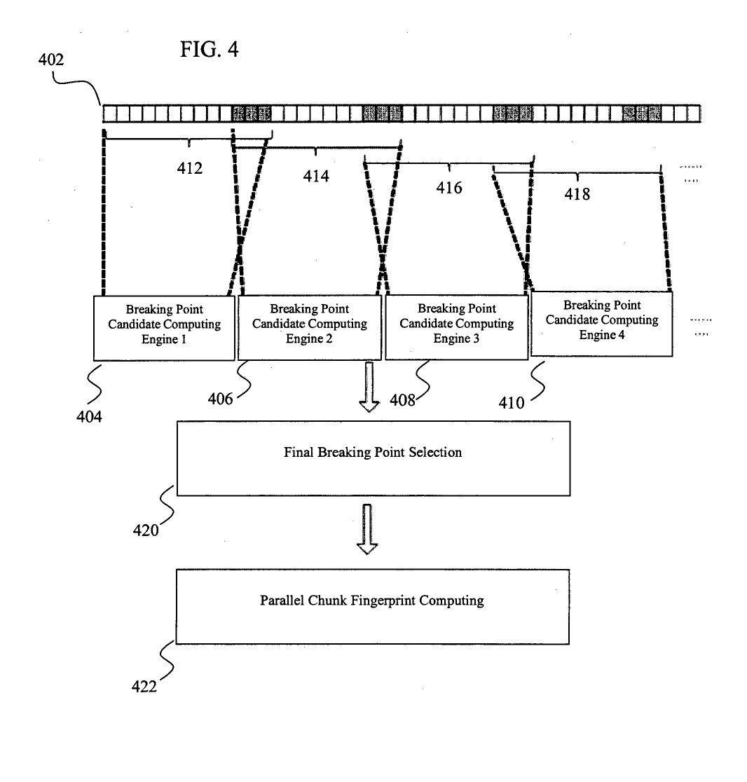

FIG. 4 illustrates a multi-stage process for determining final breaking points, according to an embodiment. The data deduplication system decouples the interleaved processes described in FIG. 2 into separate stages, which can be performed in parallel. The data deduplication system can perform the multi-stage process. In the first stage, a “breaking point candidate group” (BPCG) comprising candidate breaking points is created. A plurality of Breaking Point Candidate Computing Engines (BPCCE) 404, 406, 408, 410 divides the input data 402 into multiple initial segments that are used to construct multiple overlapping segments 412, 414, 416, 418. The BPCCEs are preferably part of the data deduplication system. Preferably, at this first stage, the BPCCEs perform the parallel computation of fingerprints for all overlapping segments and add breaking points of data blocks with fingerprints satisfying the fingerprint criteria to the BPCG. At the second stage Final Breaking Point Selection 420, the deduplication system selects final breaking points from the BPCG according to the chunk size criteria. At the third stage Parallel Chunk Fingerprint Computing 422, the deduplication system performs chunk fingerprint computing in parallel to store the fingerprints for newly found chunks. FIG. 4 illustrates a process of parallel partitioning of one input data stream, but in a different embodiment, parallel partitioning of individual input streams can also be applied to multiple input streams in parallel.

The first stage to compute the BPCG is computationally intensive, but advantageously performance can be enhanced using parallel processing. The second stage is quite fast as the deduplication system only determines whether the candidate breaking points meet the chunk size requirement. Advantageously, the benefit of the decoupled parallel processing is that the final breaking points determined in parallel are the same as the breaking points chosen by the serial data partitioning process.

There are multiple steps for the first stage of computing the BPCG. The steps are 1) overlapping segment construction 2) parallel fingerprint computing for each data block in each overlapping segment and 3) adding candidate breaking points to the BPCG.

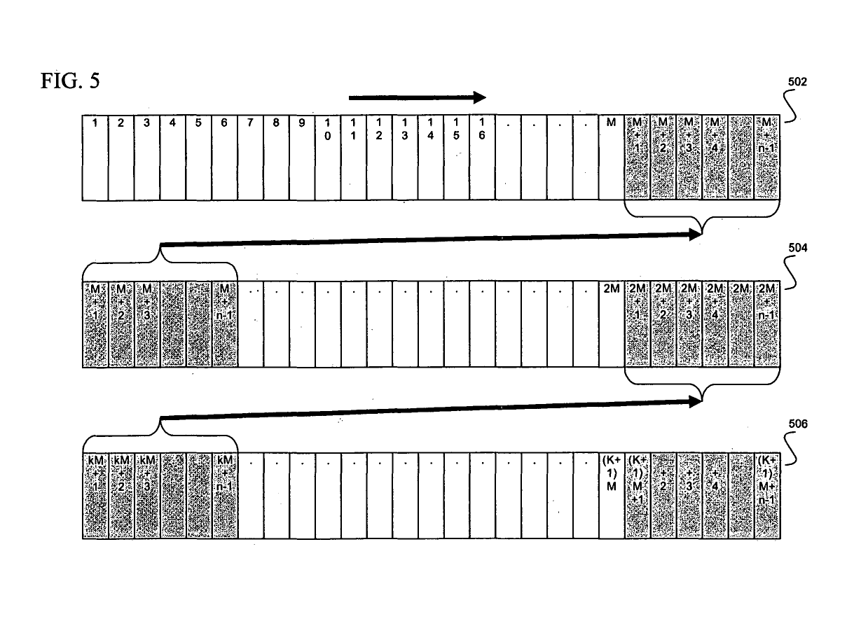

FIG. 5 illustrates construction of overlapping segments, according to an embodiment. An “overlapping segment” is an initial segment extended by appending, to the initial segment, a portion of a subsequent segment. In an embodiment, the deduplication system initially divides input data into multiple initial segments of the same size. As shown in FIG. 5, the first initial segment 502 comprises bytes [1,2,3, . . . , M]. The second initial segment 504 comprises bytes [M+1, M+2, . . . 2M]. Byte 1 is the “beginning” of the first initial segment 502, and byte M is the “end” of the first initial segment 502. Likewise, byte kM+1 is the beginning of initial segment k 506, and byte (k+1)M is the end of initial segment k 506. In another embodiment, the initial segments could have different sizes.

The deduplication system preferably appends the first n−1 bytes of data at the beginning of the (k+1)-th segment to the end of the k-th segment to construct an overlapping segment, where n is the size of the overlapping data blocks for fingerprint computing. Preferably, the size of the portion of the subsequent segment that is appended is one byte less than the size of the overlapping data blocks. In another embodiment, the size of the portion of the subsequent segment could be equal to or greater than the size of the overlapping data blocks. Preferably, the deduplication system repeats the appending process to all segments, except that a last segment at the end of the input data lacks an appended portion. Thus, each segment is extended by n−1 bytes of data, as depicted in FIG. 5. If the input data can be divided into at least two initial segments, then preferably all segments except the last segment have an appended portion. If the input data can be divided into only two initial segments, then preferably only the first segment has an appended portion. In all cases, for at least one segment of the initial segments, a portion of the subsequent segment is appended to the at least one segment to form an overlapping segment.

Once the deduplication system has computed the overlapping segments, the deduplication system applies fingerprint computing to each overlapping segment in parallel, in order to search for candidate breaking points. Advantageously, all fingerprint computations of all overlapping data blocks are performed in parallel for each segment, and the fingerprint computations for each of the segments are performed in parallel with fingerprint computations for other segments.

Since, at this stage, the deduplication system is only performing fingerprint computations and the deduplication system is not determining final breaking points, the deduplication system advantageously is able to process all overlapping data blocks for all overlapping segments in parallel. In contrast, with serial fingerprint computations, the fingerprint computing and determining whether the fingerprint criteria and chunk size criteria are satisfied is performed in an interleaved and correlated manner, which cannot be executed in parallel. In some embodiments, searching data blocks of each overlapping segment for candidate breaking points is performed either by searching the data blocks of the overlapping segment in parallel or by searching the data blocks of the overlapping segment in serial.

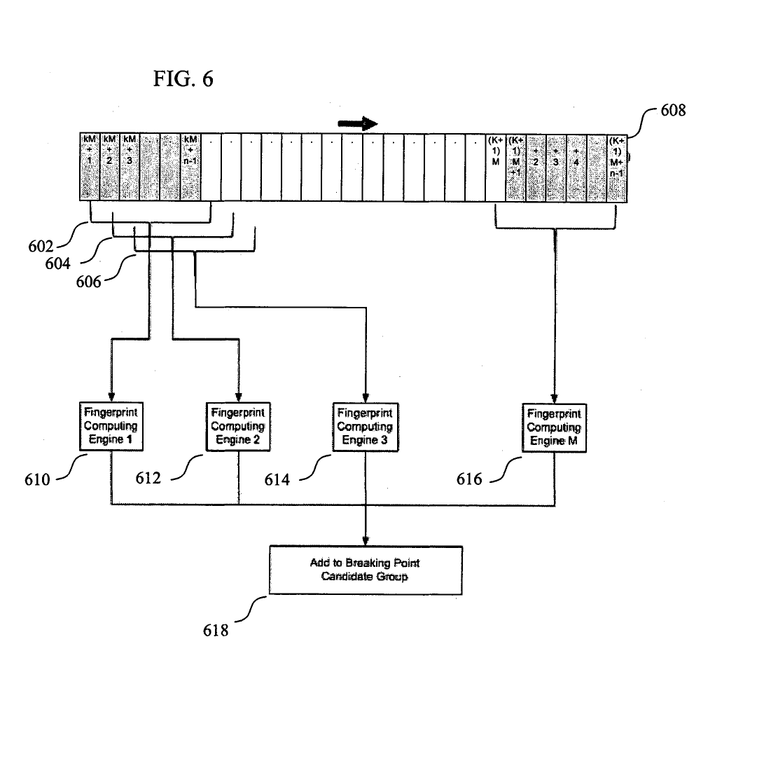

FIG. 6 illustrates searching for candidate breaking points in an overlapping segment, according to an embodiment. The data deduplication system performs parallel fingerprint computing using multiple fingerprint computing engines, e.g. 610, for overlapping data blocks 602, 604, 606 of overlapping segment k 608, according to an embodiment. For each overlapping data block, the deduplication system computes the fingerprint of the overlapping data block in parallel with the computation of the fingerprints of other overlapping data blocks. For example, the first data block 602 consisting of bytes [kM+1, kM+2, . . . , kM+n] is the input for the first fingerprint computing engine 610. The second data block 604 consisting of bytes [kM+2, kM+3, . . . , kM+n+1] is the input for the second fingerprint computing engine 612. The second data block 604 and other subsequent data blocks can be processed in parallel with the first data block 602, thus improving performance significantly. The deduplication system searches the entire overlapping segment for candidate breaking points, including the portion of the subsequent segment that is appended to each of the segments. Preferably, the first n−1 bytes of the (k+1)-th segment are also utilised in the fingerprint computations for the (k+1)-th segment. In other words, the first n−1 bytes of a (k+1)-th segment are the overlapping bytes used to search for candidate breaking points, for both the k-th segment and the (k+1)-th segment.

The fingerprint computing engines 610, 612, 614, 616 perform fingerprint computations in parallel with each other. The fingerprint computing engines 610, 612, 614, 616 are preferably part of the deduplication system. As the deduplication system determines the fingerprint for each data block, the deduplication system adds, in parallel, the candidate breaking points corresponding to those data blocks which meet the fingerprint criteria to the BPCG 618. In one embodiment, if the computed fingerprint of a data block meets a certain fingerprint criteria, then the candidate breaking point corresponding to the data block is added to the BPCG. Preferably, the deduplication system utilises one BPCG for all segments. However, a single BPCG for each segment in the deduplication system is also possible in other embodiments.

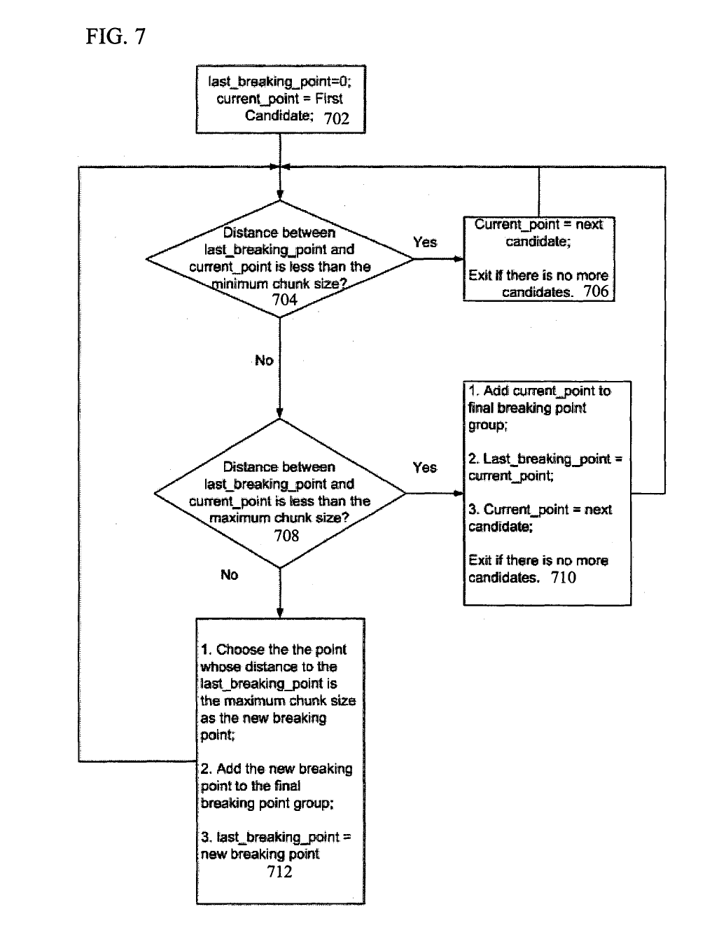

FIG. 7 illustrates a flowchart for determining a final breaking point group, according to an embodiment. At this second stage, the Final Breaking Point Selection Module (FBPSM) selects the final breaking points and computes the fingerprint for each chunk in a pipeline manner. The FBPSB is preferably part of the data deduplication system.

As shown in step 702 of FIG. 7, the FBPSM sets the initial value of last_breaking_point variable to zero (0). The FBPSM also sets the current_point variable to the first candidate breaking point in the BPCG. The deduplication system preferably sorts candidate breaking points of the BPCG from first to last, according to the “distance” of each candidate breaking point from the beginning of the input data. The distance between two points of the input data is the quantity of intervening data, e.g. bytes, between such two points.

In step 704, the FBPSM determines whether the distance between the current_point and the last_breaking_point is less than the minimum chunk size required. If yes, the FBPSM skips the current candidate in step 706 and sets the next candidate as the current_point and repeats step 704. That is, upon determining the distance of a particular candidate breaking point to be less than the minimum distance, the FBPSM excludes the particular candidate breaking point from the group of final breaking points. When all the candidate breaking points are processed, the FBPSM has finished selecting final breaking points.

If the distance is greater than the minimum chunk size, in step 708 the FBPSM determines whether the distance is less than the maximum chunk size. If yes, the FBPSM has found a qualified breaking point that will be added to the final breaking point group in step 710. That is, the FBPSM determines that a distance of a particular candidate breaking point is greater than a minimum breaking point distance and that the distance of the particular candidate breaking point is less than a maximum breaking point distance; and upon the determining, adding the particular candidate breaking point to the group of final breaking points. The FBPSM then sets the value of last_breaking_point to current_point and sets current_point to the next candidate, and repeats the process at step 704. When all the candidate breaking points are processed, the FBPSM has completed the process of selecting final breaking points.

If the distance is greater than the maximum chunk size, in step 712 the FBPSM selects the data point that has a distance to last_breaking_point equal to maximum chunk size as a new final breaking point, which is added to the final breaking point group. In other words, the FBPSM determines a distance of a particular candidate breaking point to be greater than a maximum distance; and upon determining that the distance is greater than the maximum distance, setting a chunk size of a chunk to be equal to a maximum chunk size. The FBPSM sets last_breaking_point to the new final breaking point and repeats the same process from step 704.

Determining the final breaking point group is complete when the last candidate is processed. Advantageously, determining the final breaking point group is quite fast since the FBPSM only needs to process candidates from the BPCG and perform simple comparisons with minimum chunk size and maximum chunk size to determine the final breaking points.

The deduplication system partitions, in parallel, each of the overlapping segments into chunks based on the group of final breaking points selected from the BPCG. A new chunk is identified each time a final breaking point is determined. Advantageously, for stage three, the FBPSM may start the process to compute the fingerprint for this new chunk for recording of chunk and/or chunk fingerprint history without waiting for the selection of other final breaking points. Parallel fingerprint computation for new chunks can also improve the chunk fingerprint process.

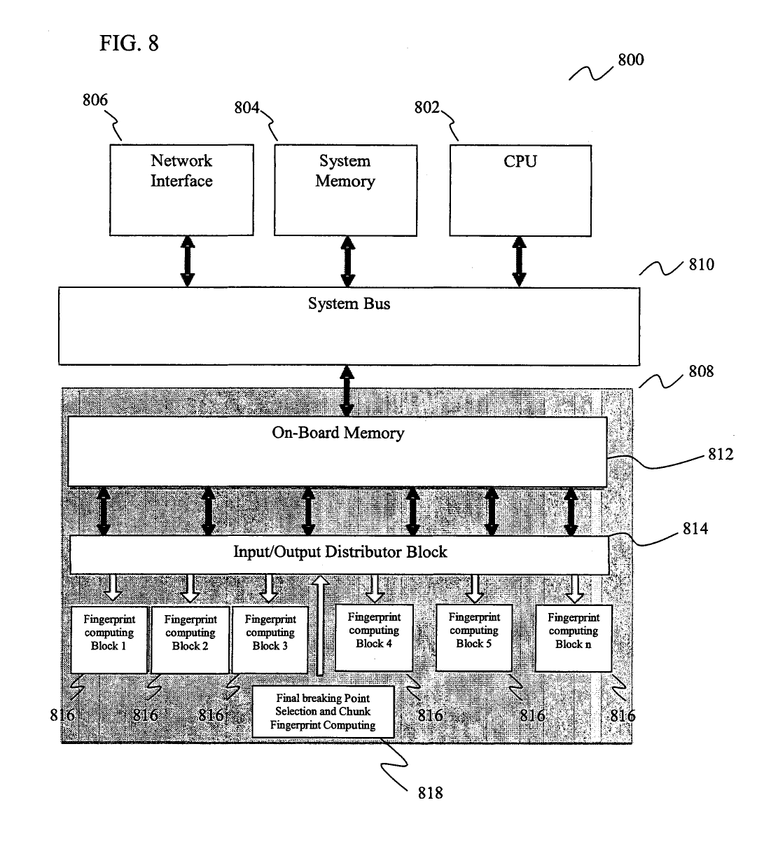

FIG. 8 illustrates a block diagram of a data deduplication system 800 with a parallel data partitioning card, according to an embodiment. Once the CPU 802 detects input data in the system memory 804 either from a network interface 806 or other interface, the CPU 802 sends the input data to a data partitioning card 808 through system bus 810 for fast parallel data partitioning. The system bus 810 can be, for example, a PCI bus or PCI-Express bus. The data is buffered in the on-board memory 812. Preferably, the input/output distributor block 814 forms all the overlapping segments as described in FIG. 5. Preferably, each overlapping segment is associated with at least one dedicated fingerprint computing block 816 for fingerprint computing in parallel, as shown in FIG. 6, to build the BPCG. Once the BPCG is determined, the Final Breaking Point Selection Module (FBPSM) 818 chooses the final breaking points as described in the flowchart of FIG. 7 and computes the corresponding chunk fingerprint in parallel. FBPSM 818 adds the fingerprints into a database for future processing, such processing including performing searches and comparisons for duplicate chunk searching. However, it will be appreciated that the present invention is not limited to any specific way of duplicate chunk searching in the data deduplication process. This step is for further processing such as duplicate chunk searching as the searching process could be based on the hash value. Please note that this invention is not for the whole data deduplication process. It focuses on how to enhance data partitioning process in parallel, which is the bottleneck of the data deduplication process. The final breaking point information and corresponding chunk fingerprints are transmitted to the CPU 802 for further processing.

An advantage of the embodiments described herein is that the final breaking points selected are the same as the breaking points selected if the data partitioning is performed in serial. In particular, no breaking points are missed due to the parallel processing of segments because any chunks that straddle a boundary between two initial segments are detected when appended portions are searched. Moreover, the data partitioning using parallel processing is much more efficient than the data partitioning using serial processing. This parallel partition system and method can significantly increase the partitioning speed in a highly scalable manner, which can be implemented both in software by multiple computing processing units (CPUs) or CPUs with multiple cores and hardware logic using field programmable gate arrays (FPGA) or application specific integrated circuits (ASIC). For example, the input/output distributor module, fingerprint computing engine, the FBPSM and chunk fingerprint computing engine can be implemented on FPGA or ASICs. The input/output distributor module, fingerprint computing engine and the final breaking point selection module and chunk fingerprint computing engine can be implemented on multiple CPUs or CPUs with multiple cores.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. For example, embodiments include the deduplication system adding each candidate breaking points of each overlapping segment to a BPCG in parallel with adding other candidate breaking points of other overlapping segments to a BPCG; and the deduplication system partitioning each overlapping segment into chunks in parallel with partitioning other overlapping segments into chunks, based on a group of final breaking points selected from said BPCG.

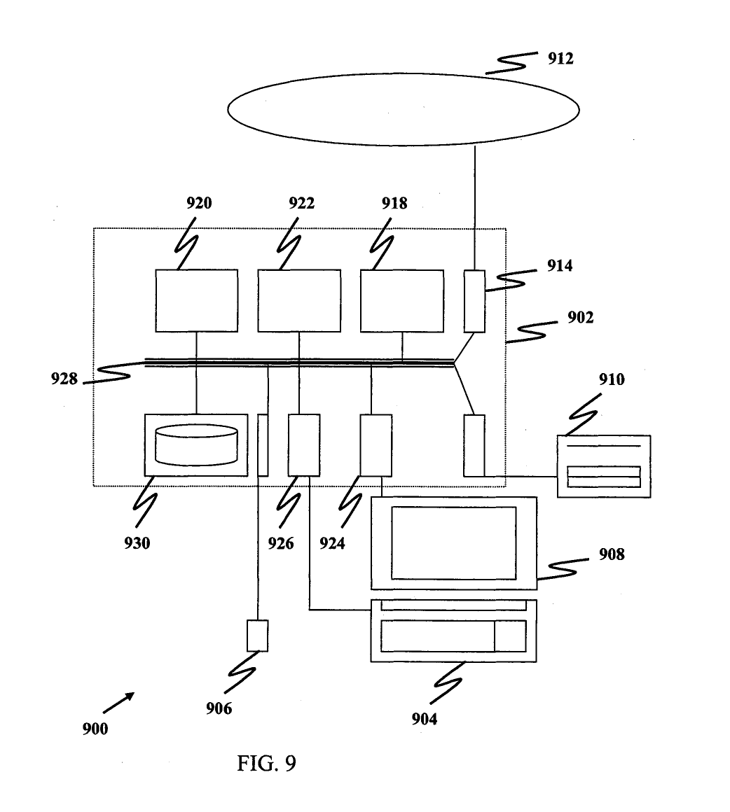

The method, data storage medium, and systems of the example embodiment can be implemented on a computer system 900, schematically shown in FIG. 9. It may be implemented as software, such as a computer program being executed within the computer system 900, and instructing the computer system 900 to conduct the method of the example embodiment.

The computer system 900 comprises a computer module 902, input modules such as a keyboard 904 and mouse 906 and a plurality of output devices such as a display 908, and printer 910.

The computer module 902 is connected to a computer network 912 via a suitable transceiver device 914, to enable access to e.g. the Internet or other network systems such as Local Area Network (LAN) or Wide Area Network (WAN).

The computer module 902 in the example includes a processor 918, a Random Access Memory (RAM) 920 and a Read Only Memory (ROM) 922. The computer module 902 also includes a number of Input/Output (I/O) interfaces, for example I/O interface 924 to the display 908, and I/O interface 926 to the keyboard 904.

The components of the computer module 902 typically communicate via an interconnected bus 928 and in a manner known to the person skilled in the relevant art.

The application program is typically supplied to the user of the computer system 900 encoded on a data storage medium such as a CD-ROM or flash memory carrier and read utilising a corresponding data storage medium drive of a data storage device 930. The application program is read and controlled in its execution by the processor 918. Intermediate storage of program data may be accomplished using RAM 920.

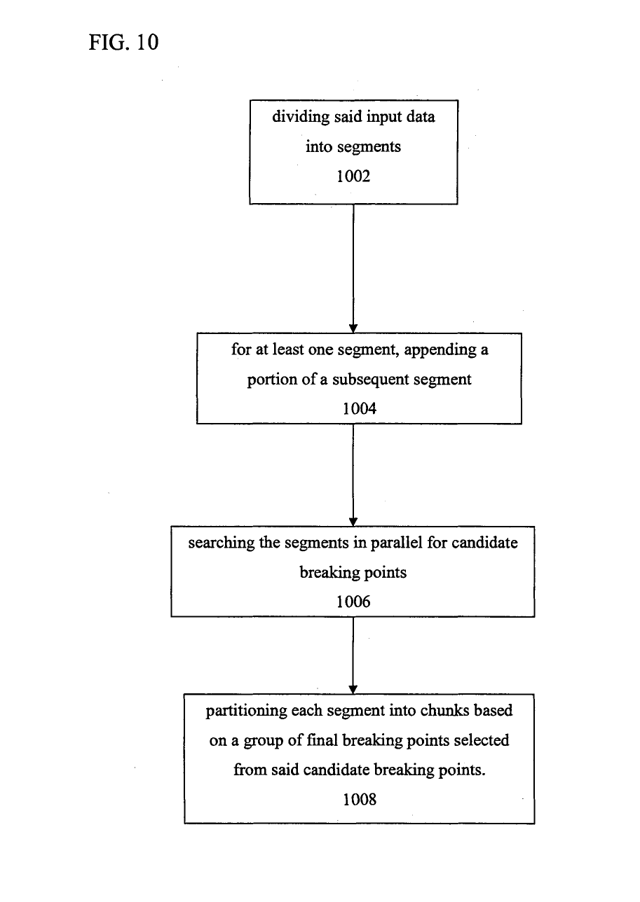

FIG. 10 illustrates a flowchart for parallel partitioning of input data into chunks for data deduplication, according to an embodiment. In step 1002, the deduplication system performs dividing said input data into segments. In step 1004, for at least one segment, the deduplication system performs appending a portion of a subsequent segment. In step 1006, the deduplication system performs searching the segments in parallel for candidate breaking points. In step 1008, the deduplication system performs partitioning each segment into chunks based on a group of final breaking points selected from said candidate breaking points.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. For example, embodiments include the deduplication system′ adding each candidate breaking points of each overlapping segment to a BPCG in parallel with adding other candidate breaking points of other overlapping segments to a BPCG; and the deduplication system partitioning each overlapping segment into chunks in parallel with partitioning other overlapping segments into chunks, based on a group of final breaking points selected from said BPCG. Further, the steps of dividing, searching, and partitioning data input can be applied to multiple input data streams in parallel.

1. A method of parallel partitioning of input data into chunks for data deduplication, comprising:
dividing said input data into segments;
for at least one segment, appending a portion of a subsequent segment;
searching the segments in parallel for candidate breaking points; and
partitioning each segment into chunks based on a group of final breaking points selected from said candidate breaking points.

2. The method of claim 1, wherein said portion of said subsequent segment comprises data at the beginning of said subsequent segment.

3. The method of claim 1, further comprising upon determining a distance of a particular candidate breaking point to be less than a minimum distance from a last breaking point, excluding said particular candidate breaking point from said group of final breaking points.

4. The method of claim 1, further comprising determining a distance of a particular candidate breaking point to be greater than a maximum distance from a last breaking point; and
upon determining that said distance is greater than said maximum distance, setting a chunk size of a chunk to be equal to a maximum chunk size.

5. The method of claim 1, further comprising determining that a distance of a particular candidate breaking point from a last breaking point is greater than a minimum breaking point distance and that said distance of said particular candidate breaking point from said last breaking point is less than a maximum breaking point distance; and
upon said determining, adding said particular candidate breaking point to said group of final breaking points.

6. The method of claim 1, wherein searching the segments in parallel for candidate breaking points further comprises adding a candidate breaking point to said group of final breaking points if a fingerprint of a data block satisfies a fingerprint criteria.

7. The method of claim 1, wherein dividing said input data into segments further comprises dividing said input data into segments of a same size or different size and wherein searching the segments is performed either by searching data blocks in parallel or by searching said data blocks in serial.

8. (canceled)

9. The method of claim 1, wherein a size of said appended portion of said subsequent segment is at most one byte less than a size of an overlapping data block and further comprising computing, in parallel, chunk fingerprints for said chunks after said partitioning.

10. (canceled)

11. The method of claim 1, wherein, except for a last segment, each of said segments is appended with a portion from a subsequent segment and wherein said steps of dividing, searching, and partitioning are applied to multiple input data streams in parallel.

12. (canceled)

13. A system for parallel partitioning of input data into chunks for data deduplication, comprising:
means for dividing said input data into segments;
means for appending, for at least one segment, a portion of a subsequent segment;
means for searching the segments in parallel for candidate breaking points; and
means for partitioning each segment into chunks based on a group of final breaking points selected from said candidate breaking points.

14. The system of claim 13, wherein said portion of said subsequent segment comprises data at the beginning of said subsequent segment.

15. The system of claim 13, further comprising means for excluding a particular candidate breaking point from said group of final breaking points upon determining a distance of said particular candidate breaking point to be less than a minimum distance from a last breaking point.

16. The system of claim 13, further comprising means for determining a distance of a particular candidate breaking point to be greater than a maximum distance from a last breaking point; and upon determining that said distance is greater than said maximum distance, setting a chunk size of a chunk to be equal to a maximum chunk size.

17. The system of claim 13, further comprising means for determining that a distance of a particular candidate breaking point from a last breaking point is greater than a minimum breaking point distance and that said distance of said particular candidate breaking point from said last breaking point is less than a maximum breaking point distance; and upon said determining, adding said particular candidate breaking point to said group of final breaking points.

18. The system of claim 13, wherein said means for searching the segments in parallel for candidate breaking points further comprises means for adding a candidate breaking point to said group of final breaking points if a fingerprint of a data block satisfies a fingerprint criteria and wherein a size of said appended portion of said subsequent segment is at most one byte less than a size of an overlapping data block.

19. (canceled)

20. A data storage medium having stored thereon computer code means for instructing a parallel processing system to execute a method of parallel partitioning of input data into chunks for data deduplication, comprising:
dividing said input data into segments;
for at least one segment, appending a portion of a subsequent segment;
searching the segments in parallel for candidate breaking points; and
partitioning each segment into chunks based on a group of final breaking points selected from said candidate breaking points.

21. The data storage medium of claim 20, said data storage medium having stored thereon further computer code means for excluding a particular candidate breaking point from said group of final breaking points upon determining a distance of said particular candidate breaking point to be less than a minimum distance from a last breaking point.

22. The data storage medium of claim 20, said data storage medium having stored thereon further computer code means for determining a distance of a particular candidate breaking point to be greater than a maximum distance from a last breaking point; and upon determining that said distance is greater than said maximum distance, setting a chunk size of a chunk to be equal to a maximum chunk size.

23. The data storage medium of claim 20, said data storage medium having stored thereon further computer code means for determining that a distance of a particular candidate breaking point from a last breaking point is greater than a minimum breaking point distance and that said distance of said particular candidate breaking point from said last breaking point is less than a maximum breaking point distance; and
upon said determining, adding said particular candidate breaking point to said group of final breaking points.

24. The data storage medium of claim 20, wherein searching the segments in parallel for candidate breaking points further comprises adding a candidate breaking point to said group of final breaking points if a fingerprint of a data block satisfies a fingerprint criteria and wherein a size of said appended portion of said subsequent segment is at most one byte less than a size of an overlapping data block.

25. (canceled)
